(19) United States
(12) Patent Application Publication
(10) Pub. No.: US 2008/0168195 A1
(43) Pub. Date: Jul. 10, 2008

(54) METHOD FOR PROVISION OF DATA OBJECTS IN A DIGITAL IMAGE INFORMATION SYSTEM

(76) Inventor: Alfons Feihl, Berg (DE)

Correspondence Address: SCHIFF HARDIN, LLP;PATENT DEPARTMENT, 6600 SEARS TOWER, CHICAGO, IL, 60606-6473, US

(21) Appl. No.: 11/971,244

(22) Filed: Jan. 9, 2008

(30) Foreign Application Priority Data
Jan. 9, 2007 (DE) 10 2007 001 390.8

(51) Int. Cl. G06F 3/00

(52) U.S. Cl. 710/52

(57) ABSTRACT

In a method for provisioning data objects in a digital image information system controlled by an electronic data management device, the digital image information system having an image storage system with at least one non-volatile image data storage for storage of the data objects and at least one client with a local data memory networked with the image storage system. For transfer of a data object from the image data storage of the image storage system to the local data memory of the client, during the transfer of a selectable first part of the data of the data object from the image data storage to the local data memory of the client at least one selectable second part of the data of the data object is transferred from the image data storage to at least one local buffer memory of the image information system. The second part of the data of the data object is transferred to the local data memory of the client after the end of the transfer of the first part of the data of the data object.

### BACKGROUND OF THE INVENTION

1. Field of the Invention

The invention is in the field of digital image information systems and concerns a method for preparing data objects in a digital image information system.

2. Description of the Prior Art

In a medical image information system, medical images generated in the form of pixel data by imaging modalities (for example computed tomography, nuclear magnetic resonance tomography, positron emission tomography, angiography and sonography systems) are sent via a communication network to an image storage system (PACS) and are therein stored together with administrative text data such as, for example, patient name, birth date, patient number, apparatus number, examination date, study number, etc.

The images generated by the modalities and associated text data are typical data designated as “data objects”. Each such data object can include one or more images that can have been generated by one or more imaging modalities. A data object often designated as an “examination” includes number of images associated with the same patient. A data object often designated as a “study” includes a number of different examinations of the same patient. A data object, for example, can include an examination, a study or a number of studies.

In medical image information systems the pixel-based data of the data objects are stored in image databanks, wherein the data objects are initially stored in a non-volatile short-term image data storage (for example a RAID (Redundant Array of Independent Disks) storage in which a number of hard drives are coupled) contained in the image storage system. After expiration of a selectable time span (for example after a diagnosis) the pixel-based data of the data objects are transferred into a non-volatile long-term image data storage contained in an image storage system for permanent archiving. The long-term image data storage is fashioned, for example, in the form of a number of coupled tape or disk storages such as CDs (Computer Discs) or DVDs (Digital Versatile Discs). Due to legal requirements it is necessary that medical images must be preserved and displayable for a longer time span of, for example, 10 to 30 years.

The administrative text data belonging to the data objects are conventionally stored in a text data storage that is different from the image data storage. In order to obtain an unambiguous association between the text data and the image data of a data object, an identifier (key) associated with the image data is contained in the text data for identification of the associated pixel data. The identifier can be part of the administrative information or can be newly generated. The information about the access to the text databank, which image data belong to a data object, and in which image databank the image data are stored, can thus be acquired.

Medical image information systems are administered by an electronic data management device that controls the generation, storage, provisioning and presentation of data objects. Presentation of data objects ensues via graphical user interfaces that are provided at screen workstations, for example what are known as finding consoles.

The image storage system with the image data storages and the screen workstations form a typical client-server architecture, wherein the screen workstations (clients) are connected via a communication network to the image storage system (image storage server system).

Medical image information systems are conventionally set up so that at least one application can be executed, within which application a user can implement specific actions. The term “application” as used herein means a computer program (application program) that includes control commands that cause the image information system to implement a desired process. For this purpose the application can be implemented on the image storage system and/or one or more clients.

In order to present a data object on a graphical user interface of a client, for example in order to consider or to assess the associated images, the data object is transferred from the image data storage (typically a short-term image data storage) containing the data object into a local data memory of the client on the basis of a user query effected at the client. The local data memory of the client can be a non-volatile data memory and/or a volatile data memory. The request, provisioning and processing of data objects conventionally ensues within an application executed in the digital image information system.

Concretely, the transfer of a data object into the local data memory of a client conventionally ensues by initially detecting the information contained in the text databank as to which image data belong to a specific data object and in which image databank these image data are stored, the basis of a user query or automatically. The data object is subsequently loaded into the local data memory of the client, and the data are sequentially transferred into the local data memory of the client via the communication network.

Although short-term image data storages are designed so as to enable a significantly faster provisioning of data objects in comparison to the long-term image data storages serving for long-term archival, it is still the case that due to the large quantity of data, the sequential transfer of images takes a relatively large amount of time.

### SUMMARY OF THE INVENTION

An object of the present invention is to provide a method for provisioning data objects in a digital image information system with which a faster provisioning of data objects to clients is enabled.

As used herein, “data object” means data which—as explained above—contain a pixel-based image portion and administrative information. An identifier (key) for identification of the pixel data of a data object, which identifier is associated with the image portion, is contained in the text portion.

The digital image information system controlled by an electronic data management device has an image storage (server) system for archiving and storage of text and pixel portions of data objects, the image storage (server) system having at least one non-volatile image data storage for storage of the image data of the data objects as well as an associated text databank for the text data belonging to the data objects. The at least one image data storage of the image storage system can be a long-term image data storage, for example in the form of a jukebox with a number of coupled magneto-optical or optical disks and/or a short-term image data storage, for example in the form of RAID hard drive storage.

The image information system furthermore has at least one client (for example screen workstation) networked with the image storage system, which client is provided with a local data memory for storage of data objects. The image information system can additionally comprise at least one imaging modality for generation of images.

A presentation of data objects ensues by means of at least one graphical user interface provided by the client. The data management device for administration of the data objects can be realized in an image storage system and/or one or more clients. Furthermore, at least one application that can be implemented on the image storage system and/or one or more clients can be executed in the digital image information system.

The digital image information system is furthermore provided with at least one local buffer memory which can be, for example, a local buffer memory of the image storage system and/or a local buffer memory of the client. In contrast to image and text data storage and in contrast to the local data memory of the client, the local buffer memory (also called a shadow memory) is a system memory (system cache) which, in order to act as a buffer, is based on a faster memory technology than the data memory to be cached. A local system cache of the client is fashioned such that data can be read from the system cache faster than from the local data memory for storage of the data objects. A local system of the image storage system is similarly fashioned so that data can be read from the local system cache of the image storage system faster than from the image data storages for storage of the image data. The local system cache is advantageously a volatile memory of the random access type RAM (Random Access Memory).

In the digital image information system according to the invention, for transfer of a data object from the at least one image data storage (advantageously a short-term image data storage) of the image storage system to the local data memory of the client, during the transfer of a determinable first part of the data of the data object to the local data memory of the client, at least one determinable second part of the data of the data object is transferred to at least one local buffer memory of the image information system. After the end of the transfer of the first part of the data object, the second part of the data object transferred to the local buffer memory is transferred to the local data memory of the client in order to complete the transfer of the data object to the local data memory of the client.

In the inventive method, the transfer time required to transfer a data object from the image data storage of the image storage system into the local data memory of the client can be reduced in an advantageous manner due to the (partially) parallel transfer of data instead of the sequential transfer in the conventional case. After the end of the transfer of the data into the local data memory of the client, the parallel transfer of a portion of the data object into a local system cache enables a relatively faster transfer of the data from the system cache into the local data memory of the client than would be possible given a transfer of the data from the image data storage of the image storage system into the local data memory of the client.

In the inventive method, if the transfer of the first part of the data of the data object from the image data storage of the image storage system into the local data memory of the client ends before the transfer of the second part of the data of the data object from the image data storage of the image storage system into the locally buffer memory of the image information system ends, the transfer of the second part of the data of the data object into the local buffer memory of the image storage system is terminated before ending and the remaining data of the second part of the data of the data object are transferred directly into the local data memory of the client.

The first part of the data of the data object is advantageously a determinable portion of the images of a data object to be transferred while the second part of the data of the data object is the remaining images of the data object to be transferred. The first part of the data of the data object and the second part of the data of the data object advantageously add up to the complete data object.

In accordance with the invention, it is advantageous when, before beginning the data transfer, it is established which portion of the data of a data object is associated with the first data object part, and which (remaining) portion of the data of a data object is associated with the second data object part. It is similarly possible the pre-set relative portions that the first data object part and the second data object part assume in the data volume of the data object, for various data objects.

In an embodiment of the inventive method, before beginning the transfer of the data object a loading parameter is calculated that specifies how many images are contained in the first part of the data object to be transferred directly into the local data memory of the client, and how many images are contained in the second part of the data object to be transferred into the locally buffer memory. If the data object to be transferred contains, for example, n images, 1 through i images are associated with the first data object part, for example, while the remaining i+1 through n images are associated with the second data object part.

In a further embodiment of the inventive method, the data set of the second data object part of the data object to be transferred (in particular the number of the images of the data object assigned to the second data object part) is determined as a function of: the at least one imaging modality used for generation of the data object; the data throughput of the image data storage of the image storage system; and the data throughput of the communication network connecting the client and the image data storage of the image storage system.

The data set of the second data object part of the data object to be transferred, in particular the number of the images of the data object assigned to the second data object part, is particularly advantageously selected such that the required transfer time for transfer of the data object from the image data storage of the image storage system to the local data memory of the client is minimal.

In a further advantageous embodiment of the inventive method, the second data part of the data object is transferred into the local buffer memory by means of a number of simultaneous threads. As used herein a “thread” means a single execution string as part of the executed process, namely the transfer of data from the image data storage into the local buffer memory. In the event that data are transferred via a number of threads, this means that the data to be transferred are transferred into the local buffer memory in parallel in a number of execution threads within a transfer process, so the transfer time required for transfer of the data can be further reduced.

In a further embodiment of the inventive method, the at least one second part of the data of the data object is transferred to a local buffer memory associated with the client.

In a further embodiment of the inventive method, the at least one second part of the data of the data object is transferred to a local buffer memory associated with the data storage system.

In a further embodiment of the inventive method, the at least one second part of the data of the data object is transferred to a local buffer memory associated with the client and simultaneously to a local buffer memory associated with the data storage system.

Control of the transfer of the first part and the at least one second part of the data of a data object, as well as a calculation of the relative proportions of these two parts of the data object, ensue via the data management device that can be provided with a cache transfer application for this purpose. The cache transfer application can be implemented in the image storage system and/or in the at least one client. In the event that the cache transfer application is implemented in the image storage system, the data can be transferred into the local buffer memory of the client via a push method while, for the case that the cache transfer application is implemented in the client, the data can be transferred into the local buffer memory of the client by a read method.

The invention also encompasses a computer-readable medium encoded with program code (computer program) for a data management device of a digital image information system controlled (as described above) by the data management device. The computer-readable program code includes control commands that cause the data management device to implement the method described above, and all embodiments.

Moreover, the invention encompasses an electronic data management device for controlling a digital image information system as described, the electronic data management device being provided with a computer-readable program code as described above.

The invention also encompasses a digital image information system that is provided with an electronic data management device as described above for control thereof.

### BRIEF DESCRIPTION OF THE DRAWINGS

FIG. 1 schematically illustrates an exemplary embodiment of the inventive digital image information system.

FIG. 2 illustrates an exemplary embodiment of the digital image information system from FIG. 1.

FIG. 3 illustrates a further exemplary embodiment of the digital image information system from FIG. 1.

FIG. 4 illustrates a further exemplary embodiment of the digital image information system from FIG. 1.

FIG. 5 is a flow chart of an exemplary embodiment of the inventive method.

### DESCRIPTION OF THE PREFERRED EMBODIMENTS

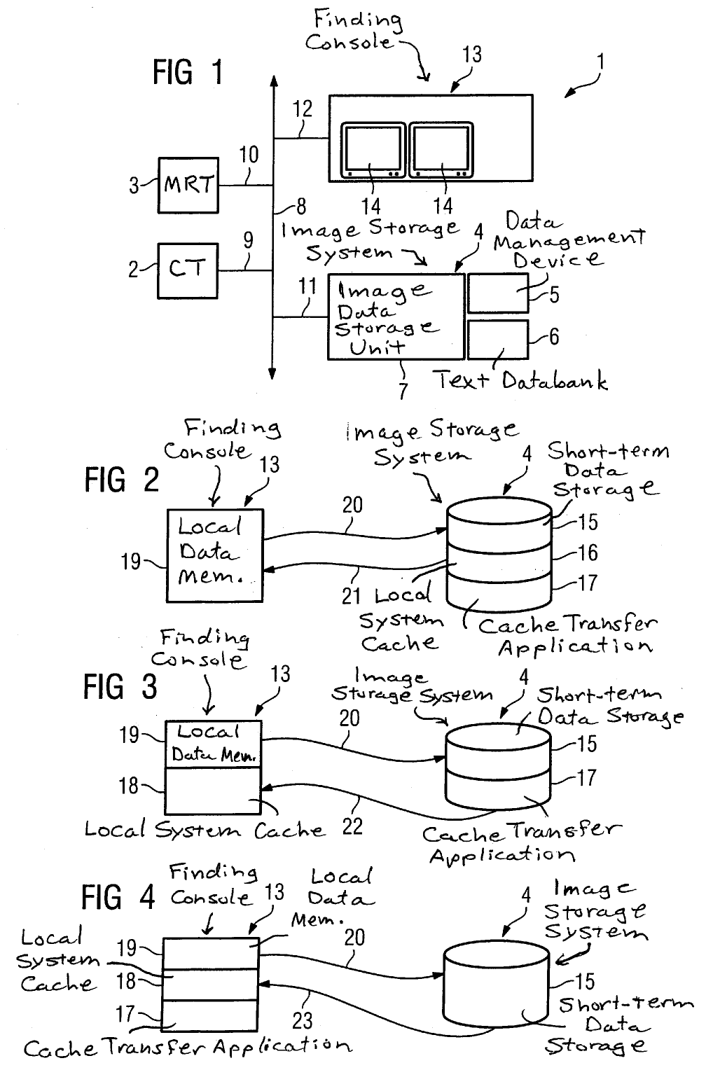

FIG. 1 shows an exemplary embodiment of an inventive digital, medical image information system, in a schematic presentation.

The medical image information system designated in total with the reference number 1 has two imaging modalities, here a computed tomography (CT) apparatus 2 and a magnetic resonance tomography (MRT) apparatus 3. Different and more or fewer than two imaging modalities can be provided in the medical image information system 1.

The image information system 1 furthermore has an image storage system (PACS) (designated in total with the reference number 4) serving for the storage and archiving of data objects as well as a finding console 13 (client) that provides two screens 14 serving as a graphical user interface. A number of such finding consoles 13 can be provided in the image information system 1. Likewise, more or fewer screens 14 can be provided at one finding console 13.

The imaging modalities 2, 3 are connected to a common data line 8 via respective data lines 9, 10. The image storage system 4 is connected via a data line 11 with the common data line 8. The finding console 13 is connected via a data line 12 with the common data line 8. The data lines 9, 10, 11, 12 and 8 form a communication network for data-networking the imaging modalities 2, 3 with the finding console 13 and the image storage system 4.

The computerized image storage system 4 has an image data storage unit 7 which can be fashioned in the form of a short-term image data storage and possibly a long-term image data storage and serves for the short-term or long-term storage of pixel anatomical of data objects. It furthermore includes a text databank 6 that serves for the storage of the administrative text data of the data objects. Moreover, the image storage system 4 has an electronic data management device 5 that serves for the administration (in particular storage, provisioning and presentation) of data objects.

In the digital image information system 1 illustrated in FIG. 1, for transfer of a data object from the image data storage 7 (advantageously a short-term image data storage) of the image storage system 4 to a local data memory of the finding console 13, during the transfer of a determinable first part of the data of the data object to be transferred to the local data memory of the finding console 13, the remaining second part of the data of the data object to be transferred is transferred to a local buffer memory of the image information system. After the end of the transfer of the first part of the data object the second part of the data object transferred to the local buffer memory is transferred to the local data memory of the finding console 13 in order to thus complete the transfer of the data object to the local data memory of the finding console 13. In the event that the transfer of the first data object part is ended before the transfer of the second data object part, it is thus advantageous when the transfer of the second data object part into the local buffer memory is terminated and the remaining data of the second data object part are transferred directly into the local data memory of the finding console 13.

Reference is now made to FIGS. 2 through 4, wherein various embodiments of the digital image information system from FIG. 1 are illustrated in an exemplary manner. The finding console 13 and the image storage system 4 are respectively schematically depicted in FIGS. 2 through 4.

In FIG. 2 the image storage system 4 has a short-term image data storage 15 for storage of data objects and a local system cache 16. A cache transfer application 17 is additionally implemented in the image storage system 4. The finding console 13 is provided with a local data memory 19 for storage of the transferred data objects.

Initiated by a user query 20 input at the finding console 13 or generated automatically by image information system, a data object comprising n images should be transferred to the finding console 13.

After calculation of first and second data object parts, the cache transfer application 17 running in the image storage system 4 transfers the first data object part (here the images 1 through i of the data object) from the short-term image data storage 15 into the local data memory 19 of the finding console 13 and simultaneously transfers the second data object part (here the images i+1 through n of the data object) from the short-term image data storage 15 into the local system cache 16. After the end of the transfer of the images 1 through i of the data object from the short-term image data storage 15 into the local data memory 19, a transfer 21 of the images i+1 through n of the data object that were transferred into the local system cache 16 into the local data memory 19 of the finding console 13 ensues.

A further exemplary embodiment of the digital image information system of FIG. 1 is schematically illustrated in FIG. 3, in which the image storage system 4 has a short-term image data storage 15 for storage of data objects and an implemented cache transfer application 17. The finding console 13 is provided with a local data memory 19 for storage of the transferred data objects and a local system cache 18.

Initiated by a user query 20 input at the finding console 13 or generated automatically by image information system, a data object having n images should be transferred to the finding console 13.

After calculation of first and second data object parts, the cache transfer application 17 running in the image storage system 4 transfers the first data object part (here the images 1 through i of the data object) from the short-term image data storage 15 into the local data memory 19 of the finding console 13, wherein a transfer 22 of the second data object part (here the images i+1 through n of the data object) from the short-term image data storage 15 into the local system cache 18 simultaneously ensues. After the end of the transfer of the images 1 through i of the data object from the short-term image data storage 15 into the local data memory 19, the images i+1 through n of the data object that were transferred into the local system cache 18 are transferred into the local data memory 19 of the finding console 13.

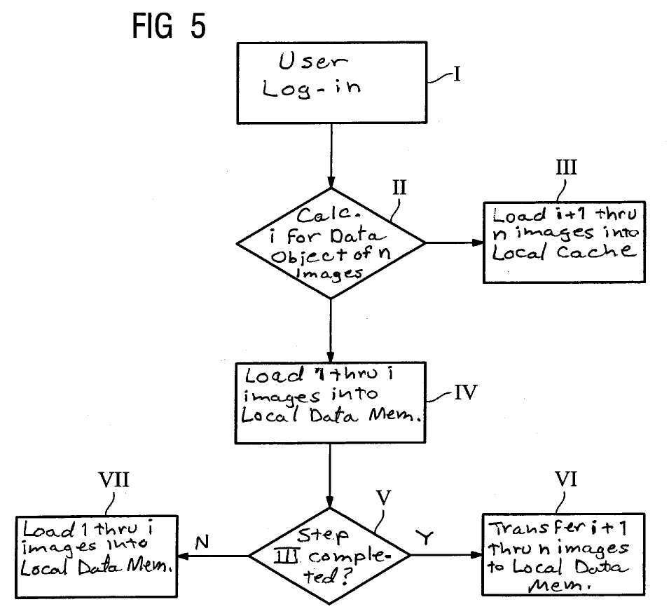

A further exemplary embodiment of the digital image information system from FIG. 1 is schematically illustrated in FIG. 4, in which the image storage system 4 has a short-term image data storage 15 for storage of data objects while the finding console 13 is provided with a local data memory 19 for storage of the transferred data objects, a local system cache 18 and an implemented cache transfer application 17.

Initiated by a user query 20 input at the finding console 13 or generated automatically by image information system, a data object having n images should be transferred to the finding console 13.

After calculation of first and second data object parts, the cache transfer application 17 running in the image storage system 4 transfers the first data object part (here the images 1 through i of the data object) from the short-term image data storage 15 into the local data memory 19 of the finding console 13, wherein a transfer 22 of the second data object part (here the images i+1 through n of the data object) from the short-term image data storage 15 into the local system cache 18 simultaneously ensues. After the end of the transfer of the images 1 through i of the data object from the short-term image data storage 15 into the local data memory 19, the images i+1 through n of the data object that were transferred into the local system cache 18 are transferred into the local data memory 19 of the finding console 13.

Reference is now made to FIG. 5, wherein a flow chart of an exemplary embodiment of the inventive method is shown:
I) Logging of a user into the image information system of the finding console 13 and selection of a data object with 1000 images for assessment.
II) Calculation of a loading parameter i for determination of the number of the images of the first and second data object parts to be transferred as well as calculation of the number t of threads for transfer of the second data object part to the local system cache. The following function is hereby used for i, t:

i,t=f(n,Mt,Rt,Nt)
wherein
   n=number of the images of the data object
   Mt=modality type (image size)
   Rt=data throughput of the short-term image data storage
   Nt=data throughput of the communication network.
i, t are determined by the function f such that an optimized data throughput (i.e. an optimally short transfer time) is required for the transfer of the data object from the short-term image data storage 15 into the local data memory 19 of the finding console 13.
III) The cache transfer application 17 loads the images i+1 through n of the data object to be transferred into the local system cache 16, 18.
IV) Simultaneously with step III), the images 1 through i of the data object to be transferred are loaded from the short-term image data storage 15 into the local data memory 19 of the finding console 13 via the common communication network.
V) The query ensues as to whether the images i+1 through n of the data object to be transferred have already been loaded into the local system cache 16, 18.
VI) In the event of yes, the images i+1 through n of the data object to be transferred are loaded into the local data memory 19 of the finding console 13.
VII) In the event of no, the images 1 through i of the data object to be transferred are furthermore loaded from the short-term image data storage 15 into the local data memory 19 of the finding console 13 via the common communication network.

The time required for transfer of a data object from an image data storage of the image storage system to a local data memory of a client can be reduced via the inventive method. This is achieved via the division of the data transfer process into at least two parallel sub-processes, whereby a first data part of the data object is transferred into the local data memory of the client and a second data part (in particular the remaining data part) of the data object is transferred into a system cache simultaneously with the first data part. The second data part is subsequently transferred from the system cache into the local data memory of the client. The parameters necessary for the cache process (which parameters describe a division of the data object into first and second data parts or, respectively, the number of the threads for the transfer of the second data part) can be adapted to the conditions of the transfer (such as network and image data storage) such that a data throughput is maximized or, respectively, a transfer time for the data object to be transferred is minimized.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for provisioning data objects in a digital information system controlled by an electronic data management device, said digital information system comprising an image storage system with at least one non-volatile image data storage unit in which a data object is stored, and at least one client with a local data memory networked with the image storage system, said digital information system further comprising at least one local buffer memory, said method comprising the steps of:
selecting a first part of the data of the data object and transferring said first part from the image data storage unit to the local data memory without passing through said local buffer memory;
selecting a second part of the data of the data object and, during transfer of said first part, transferring said second part from said image data storage unit to said at least one local buffer memory in parallel with transfer of the first part; and
transferring said second part from the local buffer memory to the local data memory of the client after ending transfer of the first part.

2. A method as claimed in claim 1 comprising associating said local buffer memory with the client.

3. A method as claimed in claim 2 comprising reading out data from said local buffer memory more quickly than reading out data from said local data memory.

4. A method as claimed in claim 1 comprising associating said local buffer memory with the data storage system.

5. A method as claimed in claim 4 comprising reading data out of said local buffer memory more quickly than reading out data from said non-volatile image data storage unit.

6. A method as claimed in claim 1 comprising, if transfer of said first part from the image data storage unit to the local data memory ends before transfer of said second part from the image data storage unit to the local buffer memory, terminating transfer of the second part to the local buffer memory and transferring remaining data of the second part directly into the local data memory of the client.

7. A method as claimed in claim 1 comprising transferring the second part into the local buffer memory via a plurality of simultaneously processed threads.

8. A method as claimed in claim 1 comprising selecting the data of the second part dependent on at least one of an imaging modality that was used to generate the data object, data throughput of the image data storage unit, data throughput of a communication network connecting the client with the image storage system.

9. A method as claimed in claim 1 comprising selecting the data of the second part to minimize a transfer time for transfer of the data object from the image data storage unit of the image storage system to the local data memory of the client.

10. A computer-readable medium encoded with programming instructions for provisioning data objects in a digital information system controlled by an electronic data management device, said digital information system comprising an image storage system with at least one non-volatile image data storage unit in which a data object is stored, and at least one client with a local data memory networked with the image storage system, said digital information system further comprising at least one local buffer memory, said programming instructions:
allowing selection of a first part of the data of the data object and causing said first part from the image data storage unit to be transferred to the local data memory without passing through said local buffer memory;
allowing selection of a second part of the data of the data object and causing, during transfer of said first part, said second part to be transferred from said image data storage unit to said at least one local buffer memory in parallel with transfer of the first part; and
causing transfer of said second part from the local buffer memory to the local data memory of the client after ending transfer of the first part.

11. A digital image information system comprising:
an image storage system with at least one non-volatile image data storage unit in which a data object is stored;
at least one client with a local data memory networked with the image storage system;
at least one local buffer memory; and
a data management device that selects a first part of the data of the data object and transfers said first part from the image data storage unit to the local data memory without passing through said local buffer memory, selects a second part of the data of the data object and, during transfer of said first part, transfers said second part from said image data storage unit to said at least one local buffer memory in parallel with transfer of the first part, and transfers said second part from the local buffer memory to the local data memory of the client after ending transfer of the first part.
